(19) United States
(12) Patent Application Publication
(10) Pub. No.: US 2009/0129059 A1
(43) Pub. Date: May 21, 2009

(54) LIGHT COLLECTING SHEET-LAMINATED LIGHT DIFFUSER PLATE

(75) Inventors: Hiroyuki KUMASAWA, Ehime (JP); Akiyoshi KANEMITSU, Ehime (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/127,183

(22) Filed: May 27, 2008

(30) Foreign Application Priority Data
Nov. 29, 2006 (JP) 2006-321457

(51) Int. Cl. G02F 1/13357; F21V 11/00; G09F 13/00

(52) U.S. Cl. 362/97.2; 362/355; 362/97.1

(57) ABSTRACT

The present invention provides a light collecting sheet-laminated light diffuser plate which can diffusely transmit transmission light (L) with sufficient luminance without causing rubbing of a light diffuser plate (2) and a light collecting sheet (4) against each other.

The light collecting sheet-laminated light diffuser plate (1) of the present invention comprises a light diffuser plate (2), a light collecting sheet (4) and an adhesive layer (3), the light collecting sheet being laminated on one side (2a) of the light diffuser plate via the adhesive layer, wherein the one side (2a) is provided with unevenness, and the light collecting sheet (4) is laminated on the one side (2a) so that the adhesive layer (3) is not contacted with the bottom (2a1) of the unevenness.

### BACKGROUND OF THE INVENTION

1. Field of the Invention

The present invention relates to a light collecting sheet-laminated light diffuser plate.

2. Description of the Related Art

A direct type liquid crystal display device (8) is a display device including a backlight device (6) and a liquid crystal cell (7) disposed on the front side of the backlight device. As the backlight device (6), for example, those including a light diffuser plate (2) and a light source (5) such as a cold cathode ray tube disposed on the back side of the light diffuser plate are widely used (see Japanese Unexamined Patent Publication (Kokai) No. 7-141908). As the light diffuser plate (2), those having a smooth surface are usually used.

It is required for the backlight device (6) to sufficiently diffuse light (L) from the light source (5) and to transmit light with higher transmittance, thus enabling illumination of the liquid crystal cell (7) with higher luminance. Japanese Unexamined Patent Publication (Kokai) No. 7-141908 proposes that the light diffuser plate (2) and a light collecting sheet (4) are used in a state of being laid one upon another via an air layer so as to satisfy such a requirement.

However, when the light diffuser plate (2) and the light collecting sheet (4) are laid one upon another via the air layer, there arises a problem that the light diffuser plate (2) and a light collecting sheet (4) rub against each other to easily cause scratches.

To solve such a problem, there is proposed a light collecting sheet-laminated light diffuser plate in which a light collecting sheet (4) is laminated over the entire surface of a light diffuser plate (2) so as not to form cavities (see Japanese Patent No. 3,123,006). However, such a conventional light collecting sheet-laminated light diffuser plate does not necessarily show enhanced luminance.

### SUMMARY OF THE INVENTION

The present inventors have intensively studied so as to develop a light collecting sheet-laminated light diffuser plate (1) which can diffusely transmit transmission light (L) with sufficient luminance without causing rubbing of a light diffuser plate (2) and a light collecting sheet (4) against each other. Thus, the present invention has been completed.

The present invention provides a light collecting sheet-laminated light diffuser plate (1) comprising a light diffuser plate (2), a light collecting sheet (4) and an adhesive layer (3),

the light collecting sheet being laminated on one side (2a) of the light diffuser plate via the adhesive layer, wherein

the one side (2a) is provided with unevenness, and

the light collecting sheet (4) is laminated on the one side (2a) so that the adhesive layer (3) is not contacted with the bottom (2a1) of the unevenness.

In the light collecting sheet-laminated light diffuser plate (1) of the present invention, since the light collecting sheet (2) and the light collecting sheet (4) are laminated to each other via the adhesive layer, there is neither positional deviation between the light collecting sheet (2) and the light collecting sheet (4), nor scratches caused by the rubbing of them against each other. Since the bottom (2a1) of unevenness of the lamination surface is not contacted with the adhesive layer (3), cavities (9) are formed between the bottom (2a1) and the adhesive layer (3) and the cavities (9) can transmit transmission light (L) with higher transmittance, thus illuminating the front face.

### BRIEF DESCRIPTION OF THE DRAWINGS

FIG. 1 a sectional view schematically showing the light collecting sheet-laminated light diffuser plate of the present invention, a backlight device comprising the same assembled thereinto, and a direct type liquid crystal display device.

FIG. 2 is a sectional view schematically showing the constitution of the light collecting sheet-laminated light diffuser plate of the present invention.

### BRIEF DESCRIPTION OF THE REFERENCE NUMERALS

1: Light collecting sheet-laminated light diffuser plate
2: Light diffuser plate
2a: One side
3: Adhesive layer
4: Light collecting sheet
5: Light source
6: Backlight device
7: Liquid crystal cell
8: Direct type liquid crystal display device
9: Cavities
L: Light

### DETAILED DESCRIPTION OF THE INVENTION

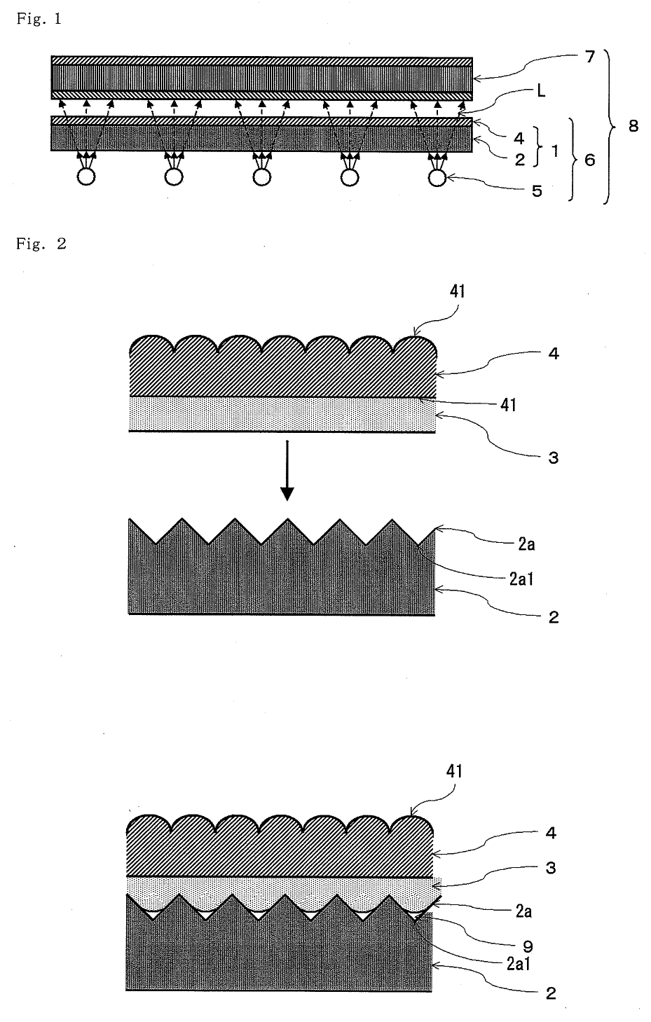

The light collecting sheet-laminated light diffuser plate (1) of the present invention will be described below with reference to FIG. 1. As the light diffuser plate (2) constituting the light collecting sheet-laminated light diffuser plate (1) of the present invention, for example, a plate-shaped molding comprising a transparent material and a light diffusing agent dispersed in the transparent material is usually used.

The transparent material includes, for example, inorganic glass and a transparent resin, and a transparent thermoplastic resin is used as the transparent resin in view of ease of molding. Examples of the transparent thermoplastic resin include a polycarbonate resin, an ABS resin (an acrylonitrile-butadiene-styrene copolymer), a methacryl resin, a methyl methacrylate-styrene copolymer resin, a polystyrene resin, an acrylonitrile-styrene copolymer (AS) resin, and a polyolefin resin such as a polyethylene resin or a polypropylene resin.

The light diffusing agent is a powder which is incompatible with the transparent material and shows a refractive index which is different from that of the transparent material, and also has a function of diffusing transmission light (L) which transmits the light diffuser plate (2). The light diffusing agent may be either an inorganic powder made of an inorganic material, or an organic powder made of an organic material.

Examples of the inorganic material constituting the inorganic powder include silica, calcium carbonate, barium sulfate, titanium oxide, aluminum hydroxide, inorganic glass, mica, talc, white carbon, magnesium oxide and zinc oxide.

Examples of the organic material constituting the organic powder include methacrylic crosslinked resin particles, methacrylic high-molecular weight resin particles, styrenic crosslinked resin particles and siloxane-based crosslinked resin particles.

The particle diameter of the inorganic and the organic particles used as the light diffusing agent is usually from 0.1 to 50 μm.

The amount of the light diffusing agent varies depending on the objective degree of diffusion of transmission light (L) and is usually from 0.01 to 20 parts by mass, and preferably from 0.1 to 10 parts by mass, based on 100 parts by mass of the transparent resin.

The thickness of the light diffuser plate (2) is usually from 0.1 to 10 mm. The area of the light diffuser plate (2) varies depending on the size of the objective backlight device (6), namely, the size of the liquid crystal display device (8), and is usually a size measuring 20 cm×30 cm to 150 cm to 200 cm.

On one side (2a) of the light diffuser plate (2), the light collecting sheet (4) is laminated, and the one side (2a) is provided with unevenness. The unevenness on the one side (2a) may be a matted surface composed of random unevenness, or may have a structure with V-shaped grooves arranged over the entire surface.

When the unevenness is a matted face, the ten-point average roughness (Rz) of the unevenness is usually from 5 to 100 μM.

When the unevenness has a structure with V-shaped grooves arranged over the entire surface, the depth (H) is usually from 5 μm to 1 mm, the apex angle (α) is usually from 40 to 120°, and the pitch (P) is usually from 3 μm to 3.5 mm.

The light collecting sheet (4) to be laminated on one side (2a) of the light diffuser plate (2) is made of a transparent material and is a sheet in which a light collecting microlens (41) such as a prism microlens, a convex microlens or a lenticular lens is disposed over the entire surface of the opposite side of the side to be laminated with the light diffuser plate (2). The sheet collects transmission light (L) toward normal direction which transmits the light diffuser plate (2) while diffusing, and thus the front side is illuminated with high luminance.

It is possible to usually use, as the light collecting sheet (4), those made of base materials such as thermoplastic resins, for example, a polycarbonate resin, an ABS resin (an acrylonitrile-butadiene-styrene copolymer), a methacryl resin, a methyl methacrylate-styrene copolymer resin, a polystyrene resin, an acrylonitrile-styrene copolymer (AS) resin, and a polyolefin resin such as a polyethylene resin or a polypropylene resin. The thickness of the light collecting sheet (4) is usually from 0.02 to 5 mm, and preferably 2 mm or less. Commercially available sheets can be used as the light collecting sheet, and a commercially available light collecting sheet (4) includes, for example, “BEF” (comprising a polyester film having a thickness of 125 μm and an acrylic resin layer having a thickness of 30 μm formed on the polyester film, V-shaped grooves having an apex angle (α) of 90° and a depth of 25 μm being formed at a pitch of 50 μm on the acrylic resin layer) available from Sumitomo 3M Ltd. and “ESTINA” available from Sekisui Film Co., Ltd.

The light collecting sheet (4) is laminated to the light diffuser layer (2) via the adhesive layer (3). The adhesive layer (3) is a layer made of an adhesive such as an acrylic adhesive, a urethane-based adhesive, a polyether-based adhesive or a silicon-based adhesive. The thickness is usually 10 μm or more in view of lamination strength of the light collecting sheet (4), and is usually 30 μm or less in view of the fact that it is easy to prevent the bottom (2a1) of unevenness from contacting with the adhesive layer (3).

The light collecting sheet (4) is laminated on the one side (2a) of the light diffuser layer (2) so that the adhesive layer (3) is not contacted with the bottom (2a1) of the unevenness provided on the one side (2a).

When the light collecting sheet (4) is laminated so that the adhesive layer (3) is not contacted with the bottom (2a1) of the unevenness, the adhesive layer (3) may be formed over the entire lamination surface (4a) of the light collecting sheet (4) and the adhesive layer (3) may be laminated on the light collecting sheet (4) toward the one side (2a) of the light diffuser plate (2) in air, followed by application of pressure, for example. The light collecting sheet (4) can be laminated on the one side (2a) of the light diffuser plate (2) without contacting the adhesive layer (3) with the bottom (2a1) by increasing the depth (H) of the unevenness to be provided on the one side (2a) of the light diffuser plate (2), decreasing the thickness of the adhesive layer (3), using an adhesive having a comparatively high viscosity as the adhesive constituting the adhesive layer (3), or decreasing the pressure to be applied when the light collecting sheet (4) is laminated.

Regarding this light collecting sheet-laminated light diffuser plate (1) of the present invention, since the adhesive layer (3) is not contacted with the bottom (2a1) of the unevenness provided on the one side (2a) of the light diffuser plate (2), cavities (9) exist on the bottom (2a1). The entire area (S₉) of the cavities (9) usually accounts for 10% or more, and preferably 30% or more, of the entire area (S₁) of the light collecting sheet-laminated light diffuser plate (1) in view of the fact that the front side can be illuminated with high luminance, and usually accounts for 90% or less, and preferably 70% or less, in view of the lamination strength between the light collecting sheet (4) and the light diffuser plate (2).

When the entire area (S₉) of the cavities (9) is large, the lamination strength of the light collecting sheet (4) may be insufficient. In such a case, the size of the light diffuser plate may be larger than the screen size of the objective liquid crystal display device (8) and the adhesive layer (3) may be laminated on the light collecting sheet (4) by sufficiently contacting with the bottom (2a1) of the unevenness at the peripheral portion of the light diffuser plate (1) so as not to form cavities (9). The adhesive layer (3) can be laminated by sufficiently contacting with the bottom (2a1) of the unevenness when the thickness of the adhesive layer (3) at the peripheral portion of the light diffuser plate (1) is increased.

At the peripheral portion of the light diffuser plate (1), the light collecting sheet (4) may be fixed to the light diffuser plate (1) using a frame body (not shown).

As shown in FIG. 1, the light collecting sheet-laminated light diffuser plate (1) of the present invention can be assembled into the backlight device (6) when used. The backlight device (6) includes the light collecting sheet-laminated light diffuser plate (1) of the present invention and the light source (5) disposed at the back side of the light collecting sheet-laminated light diffuser plate (1), and the light collecting sheet-laminated light diffuser plate (1) is disposed so that the light collecting sheet (4) positions at the front side.

As shown in FIG. 1, the backlight device (6) can be assembled into the direct type liquid crystal display device (8). The direct type liquid crystal display device (8) includes the backlight device (6), and a liquid crystal cell (7) disposed at the front side of the backlight device (6).

### EXAMPLES

The present invention will be described in more detail below by way of Examples, but the present invention is not limited to the following Examples.

### Example 1

A light collecting sheet-laminated light diffuser plate (1) was obtained by laminating a light collecting sheet (4) (which was assembled into a backlight device (6) constituting a commercially available liquid crystal display device (8) when used, and V-shaped grooves having an apex angle (α) of 90° and a depth of 25 μm were formed at a pitch of 50 μm on one side of a polyester film having a thickness of 150 μm) on a matted light diffusing plate (2) whose one side (2a) is composed with random unevenness via a colorless transparent adhesive layer (3). The ten-point average roughness (Rz) of the unevenness of the matted surface formed on the one side (2a) of the light diffuser plate was measured in accordance with JIS B0601:2001, and it was found to be 25.3 μm.

Regarding this light collecting sheet-laminated light diffuser plate (1), the bottom (2a1) of the unevenness of the one side was not contacted with the adhesive layer (3) and cavities (9) existed, and the entire area (S₉) of the cavities (9) accounted for 50% of the entire area (S₁) of the light collecting sheet-laminated light diffuser plate (1).

A cold cathode ray tube (5) was disposed on the opposite side of the light collecting sheet (4) of the light collecting sheet-laminated light diffuser plate (1). After illumination, the luminance of light (L) emitted to the light collecting sheet (4) side was measured, and it was found to be 9,136 cd/cm².

### Comparative Example 1

A light collecting sheet-laminated light diffuser plate (1) was obtained by laminating the same light collecting sheet (4) as that used in Example 1 on a matted light diffusing plate (2) whose one side (2a) is composed with random unevenness via a colorless transparent adhesive layer (3). The ten-point average roughness (Rz) of the unevenness of the matted surface formed on the one side (2a) of the light diffuser plate was measured in accordance with JIS B0601:2001, and it was found to be 1.79 μm. Regarding this light collecting sheet-laminated light diffuser plate (1), the bottom (2a1) of the unevenness of the one side was contacted with the adhesive layer (3) and cavities (9) scarcely existed, and the entire area (S₉) of the cavities (9) accounted for less than 1% of the entire area (S₁) of the light collecting sheet-laminated light diffuser plate (1).

A cold cathode ray tube (5) was disposed on the opposite side of the light collecting sheet (4) of the light collecting sheet-laminated light diffuser plate (1). After illumination, the luminance of light (L) emitted to the light collecting sheet (4) side was measured, and it was found to be 7,005 cd/cm².

What is claimed is:

1. A light collecting sheet-laminated light diffuser plate comprising a light diffuser plate, a light collecting sheet and an adhesive layer,
the light collecting sheet being laminated on one side of the light diffuser plate via the adhesive layer, wherein
the one side is provided with unevenness, and
the light collecting sheet is laminated on the one side so that the adhesive layer is not contacted with the bottom of the unevenness.

2. A backlight device comprising the light collecting sheet-laminated light diffuser plate according to claim 1, and a light source disposed on the back side of the light collecting sheet-laminated light diffuser plate, wherein
the light collecting sheet-laminated light diffuser plate is disposed so that the light collecting sheet positions at the front side.

3. A direct type liquid crystal display device comprising the backlight device according to claim 2, and a liquid crystal cell disposed at the front side of the backlight device.
